(19) United States
(12) Patent Application Publication
(10) Pub. No.: US 2018/0101614 A1
(43) Pub. Date: Apr. 12, 2018

(54) Machine Learning-Based Data Aggregation Using Social Media Content

(71) Applicant: Crowdynews, Groningen (NL)

(72) Inventors: Edwin Kuipers, Groningen (NL); Gerben van Eerten, Midwolda (NL); Giel Stekelburg, Groningen (NL); Jorrith Schaap, Groningen (NL); Daniel Illouz, Groningen (NL); Dinos Theodorou, Heerenveen (NL)

(21) Appl. No.: 15/291,955

(22) Filed: Oct. 12, 2016

(51) Int. Cl. G06F 17/30; G06N 99/00

(52) U.S. Cl. CPC G06F 17/30867; G06N 99/005

(57) ABSTRACT

Machine learning-based data aggregation using social media content is described herein. An example method includes receiving news content from a plurality of online sources, parsing the news content to determine keywords or phrases related to topics of interest, creating a search query from the keywords or phrases, searching one or more social networks for social media content that matches the keywords or phrases in the search query, processing the social media content by at least one of filtering and ranking, and providing the processed social media content to an individual.

### FIELD OF THE INVENTION

The present technology is directed to systems and methods that provide machine learning-based data processing, aggregation, and crowdsourcing based on social media content related to topics extracted from online content.

### SUMMARY

According to some embodiments, the present technology is directed to a method comprising: (a) receiving news content from a plurality of online sources; (b) parsing the news content to determine keywords or phrases related to topics of interest; (c) creating a search query from the keywords or phrases; (d) searching one or more social networks for social media content that matches the keywords or phrases in the search query; (e) processing the social media content by at least one of filtering and ranking; and (f) providing the processed social media content to an individual.

In some embodiments, the present disclosure is directed to a system of one or more computers which can be configured to perform particular operations or actions by virtue of having software, firmware, hardware, or a combination of these installed on the system that in operation causes or cause the system to perform the actions and/or method steps described herein. One or more computer programs can be configured to perform particular operations or actions by virtue of including instructions that, when executed by the data processing apparatus, cause the apparatus to perform the actions. One general aspect includes actions such as: (a) receiving news content from a plurality of online sources; (b) parsing the news content to determine keywords or phrases related to topics of interest; (c) creating a search query from the keywords or phrases; (d) searching one or more social networks for social media content that matches the keywords or phrases in the search query; (e) processing the social media content by at least one of filtering and ranking; and (f) providing the processed social media content to an individual.

In another embodiment, the present disclosure comprises: (a) an aggregation server that receives news content from a plurality of online sources; (b) a parsing server that parses the news content to determine keywords or phrases related to topics of interest; (c) a social network server that: (i) creates a search query from the keywords or phrases; (ii) searches one or more social networks for social media content that matches the keywords or phrases in the search query; (d) a filtering server that processes the social media content by at least one of filtering and ranking; and (e) wherein the aggregation server is further configured to provide the processed social media content to an individual.

In another embodiment, the present disclosure comprises a method comprising: (a) receiving news content from one or more online sources; (b) parsing the news content to determine keywords or phrases related to topics of interest; (c) creating one or more search queries from the keywords or phrases, where the one or more search queries is tailored to the requirements of specific social networks; (d) searching one or more social networks for social media content that matches the keywords or phrases in the search query; (e) processing the social media content by at least one of filtering and ranking; and (f) providing the processed social media content within a widget on a webpage in association with the news content.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of an example system, constructed in accordance with the present disclosure.

FIG. 2 is a schematic diagram of another example system, constructed in accordance with the present disclosure.

FIG. 3 is a schematic diagram of another example system, constructed in accordance with the present disclosure.

FIG. 4 is a flow chart of an example method of the present disclosure.

FIG. 5A is a mockup of an example webpage with a widget, constructed in accordance with embodiments of the present disclosure.

FIG. 5B is a mockup of an example webpage comprising a social media stream created from curated social media content.

FIG. 6 is an example computing device that can be used to practice aspects of the present technology.

### DETAILED DESCRIPTION

The present disclosure is directed to systems and methods of machine learning, such as natural language processing, that utilize online content to curate content from social networks or other similar online sources. In one embodiment, online content from news sources is processed with machine learning techniques to determine valuable keywords or phrases such as subject matter, names, events, and so forth.

The keywords and/or phrases are used to create a search query that is used to search one or more social media platforms. In one embodiment, the search query can be tailored to the requirements of individual social media platforms.

The search queries are executed against the social media platforms and volumes of content are returned. For context, hundreds of millions of instances of social media content are generated on a daily basis. For example, it is estimated that there are over 300 million tweets produced daily on Twitter™ alone. This includes content in various languages. Unfortunately, the volume of social media content creates what is referred to as “noise” meaning that social media content includes a volume of low quality or low value content. For example, on the Twitter™ platform many users will generate content through re-tweeting or sharing of other original content. This process creates noise because the volume of non-original material is low. Additionally, many users will tweet about topics but the content is of little relevance to the topic.

The present disclosure provides systems and methods that can curate social media content that is relevant (to the topics extracted from the news content and/or the personal preferences of the end user). The social media content can also be filtered for originality and authoritativeness. For example, social media content can be filtered and ranked such that authors who are authoritative on the topics extracted from the news content are selected and displayed with priority over social media content from less authoritative sources.

This curated social media content can be provided to end users through the use of a widget displayed within a webpage. In one embodiment the widget is displayed proximate a news story or news feed that includes the content for which the social media content was obtained.

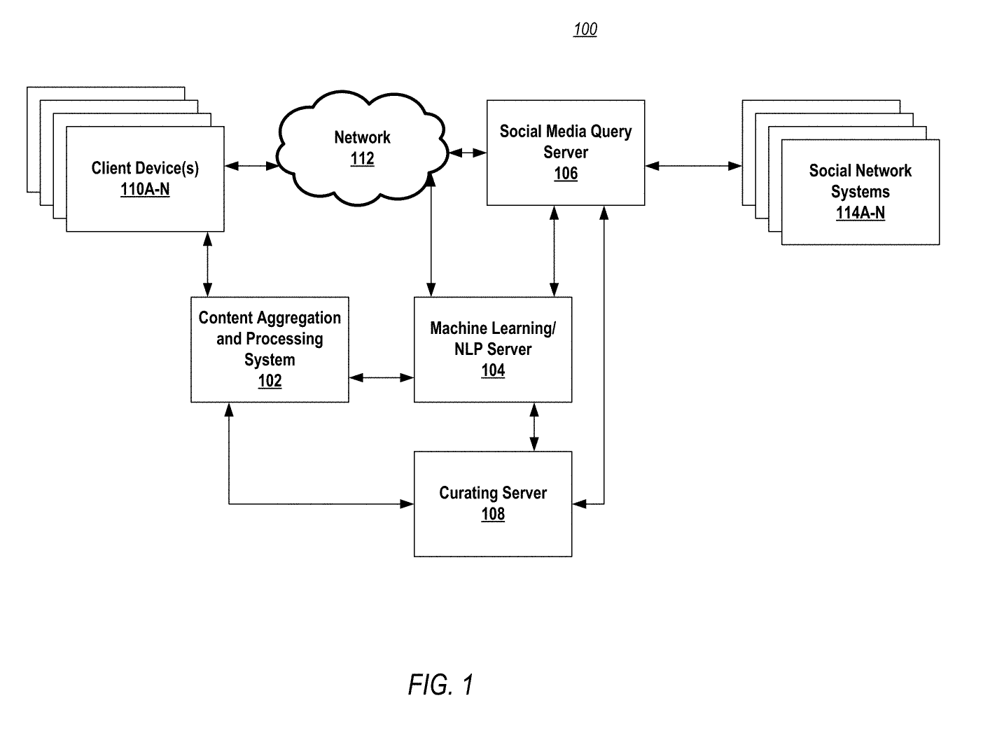

These and other advantages of the present disclosure are described in greater detail herein with reference to the collective drawings (e.g., FIGS. 1-6).

FIG. 1 illustrates an example system 100 of the present technology. The system 100, in some embodiments, comprises a content aggregation and processing system 102, a machine learning/natural language processing (NLP) server 104, a social media query server 106, and a curating server 108. It will be understood the system 100 can comprise additional or fewer components than those illustrated in FIG. 1. Readers can access the processing system 102 using a client device, such as client devices 110A-N. Each of the components described above can be communicatively coupled using at least one type of network 112, such as the Internet for example.

In some embodiments of the processing system 102 is configured to receive online news content such as articles generated by various new sources. Each instance of online news content comprises textual content. The news articles will typically comprise various topics for subject matter that are relevant to the reader regarding an event. While examples disclosed herein contemplate the processing of text from written/electronic textual content such as HTML pages or PDF content, the processing system 102 can also be utilized to process audio news content as well as any other news content from which natural language processing techniques can be used to extract content. That is, the processing system 102 can utilize both speech-to-text as well as text-to-speech functionality.

In some instances, the processing system 102 can obtain a plurality of news articles on the same topic from a plurality of online sources. This allows the processing system 102 to obtain a cross-section of content from numerous sources, allowing for the reader to receive a diverse base of content on a particular topic. The processing system 102 can utilize a Rich Site Summary (RSS) feed or other newsfeed in some embodiments.

According to some embodiments, the processing system 102 can receive inputs comprising RSS feeds for article topics, advertisement campaigns for product topics, social media trend analysis for trending topics, manually defined topics, and any combinations and permutations thereof.

With respect to RSS feeds, the processing system 102 utilizes RSS feeds as input to be able to fetch article content from the Internet and to be able to detect article updates. The RSS feeds are updated periodically, and for each item in the RSS feed, the contents are compared with the cached contents to assess if an article has changed. New articles and changed articles are fetched by using Web Content Extraction.

In some embodiments, articles are fetched from the Internet using an OEmbed module that is a component part of the processing system 102. The OEmbed module ensures that complete article contents are fetched from a corresponding website. The OEmbed module uses JavaScript selectors that specify where the content is located on the website. The output of the OEmbed module is a document which contains a title, a description, the article content and the canonical URL. These fields are used for extracting features from an article or other document.

Advertisement campaigns are used as starting point for creating product related topics. These campaigns are uploaded to the platform by a publisher. Each campaign contains a collection of products and each product contains a collection of words, phrases and geographical information.

The textual collections are used to generate social media inputs. These social media inputs are used to collect data sets from social media. The correlation module ensures that the social media inputs are a correct translation of the advertisement campaign and discards any input that is resulting in too many irrelevant items.

In addition to the inputs above, automatically detected trends can be used as input for the platform. Trends are detected by continuously analyzing streams of social media items. The text of each item is split into tokens and for each token a model is created for the short term and for the long term. The trend score is derived by comparing the short term model to the long term model. Each token that is suddenly used in a more frequent way as compared to the long term model is considered to be a trending token. Trending tokens are further processed to generate clusters of tokens and clusters of social media items.

In one example, a news article will reference the product launch of a new product, such as a cell phone. The news article will include information such as product name, product type, company information, and product features—just to name a few. The processing system 102 can utilize search engines or dedicated links to news outlets to search for additional articles relevant to this product launch. To be sure the processing system 102 can be used to retrieve a single article or a plurality of articles relating to a single topic.

According to some embodiments the processing system evaluates the news content to extract keywords and/or phrases. The processing system 102 can also refine the extracted key words or phrases by removing or ignoring textual content that is not indicative of topics for information that is relevant to the subject matter of the news article. For example, parts of speech such as indefinite articles and less relevant information are determined and ignored. That is, the processing system 102 can examine the actual content for words that are repeated frequently, phrases that indicate important subject matter, and the like. Company or entity information can be used by the processing system 102 to cross reference and determine what content is likely to be important in the news article. In some embodiments, the processing system 102 can look for textual content that includes highly charged language or other words of importance. In another example, a podcast or radio program can be processed to extract important keywords or phrases.

In some embodiments, the processing system 102 can evaluate words and extensions of words to determine topical relevancy such as the words “launch” and “launching” being indicative of the same topic of a product launch.

In some embodiments, the processing system 102 processes article content fields with language dependent components to transform a document into a collection of features. These features differ in nature. For example, there are textual features, conceptual features, and referencing features. The text fields are processed tokenizing the text into lists of words, and these words are stemmed and mapped to generic stems. In one embodiment, the stems are collected from the different text fields and summed up in a weighted fashion to create an ordered list of stems.

In some embodiments, the text fields are processed by separate Named Entity Recognition (NER) systems that extract named entities from the text. Different systems are used to recognize named entities, pattern-based, Natural Language Processing (NLP)-based and Machine Learning-based—just to name a few. The pattern-based NER subsystems extract possible named entities by using regular expressions that extract proper names. The NLP-based subsystems use grammatical language models to extract named entities based on their position in a sentence. The machine learning-based subsystems use large databases composed with human knowledge, like Wikipedia, and analyze phases together with their context to pinpoint the exact concept of a certain phrase by referencing the Wikipedia article. In some embodiments, the NER features are used to change the importance of the tokens and as separate features.

The URL of the article is added to the feature set as a referencing feature. These features together with their occurrences in the text are used to generate queries for social media services.

Regardless of the natural language processing methods used by the processing system 102, once keywords or phrases are determined, the social media query server 106 is executed to generate or create a social media query that incorporates the key words or phrases determined from the news article. In some embodiments the social media query server 106 can utilize query formats specified and used by application programming interfaces (APIs) of various social media platforms. For example the API used to search Twitter may have different search parameter requirements than the API uses to search Facebook. The social media query server 106 can communicate with social network systems 114A-N using various APIs.

In one example it is assumed that the news article references the product launch of a new cell phone such as the iPhone. The news article includes words such as “iPhone seven” and references the month of “September,” as well as “Apple.” The search query could functionally be represented as “iPhone seven+September+Apple+launch.” Again, the construction of the search query is dependent upon the requirements of the social media platform, so it is conceivable that the social media query server 106 may generate various search queries for the same news content.

In some embodiments, document features are transformed by the query server 106 into queries for social media services. Depending on the API capabilities, different transformers are used. Some APIs support querying for a URL, some support fuzzy queries and perform tokenization and stemming, some support Boolean queries, and some only support searches for one exact keyword.

Services that support queries for items that contain a URL are always queried by using the canonical UR. For services that support fuzzy queries, the top n-stems of textual features are used to formulate one query. For services that support Boolean queries, combinations of the best words selected from the top n textual features are used to formulate queries that result in items that always contain all words in the query. For services that only support searching for exact one keyword, the best words from the top n-features are used to create n queries.

In this way, the system ensures that the most relevant and/or the least irrelevant content is retrieved from the social media services.

It will be understood that social media services often pose restrictions on the number of queries that a user can perform on the API. Depending on the effectiveness of the last search, depending on the age of the last search, and depending on the age of the article, all queries are ranked and executed in an order from most important to least important. In this way, the query server 106 ensures that the most relevant content is retrieved as fast as possible from the social media services.

As mentioned briefly above, it is likely that execution of searches against the social media platforms will result in the social media query server 106 receiving a high-volume of responses, many of which would be classified as noisy responses. In order to provide the end-user with highly relevant and accurate information, the curating server 108 can receive the search responses and apply at least one of filtering and/or ranking to curate or pare down the search results prior to providing the social media content to the end-user.

In one embodiment, all the content items retrieved from the social media services are analyzed and transformed into the feature space of the articles. The text of the items is analyzed with the same language dependent component to tokenize and stem them. For the NER subsystems, the text of the item is compared to the textual references of the NER features in the article text to map them to the same feature space. Items that contain a URL, or that are retrieved by a query for a URL, get this URL as a feature. The social media items and the article are matches using the abstract feature space. Any match is further processed in the scoring, filtering and ranking—just to name a few.

One example of filtering that can be provided by the curating server 108 includes excluding social media content that includes retweets or other rehashing of original content. By way of example, if a tweet provided on Twitter™ by an original author is retweeted a plurality of times by other users without adding any additional original content or any editorialization, the retweets will be ignored by the system. The curating server 108 can also be configured to exclude other types of irrelevant or marginally relevant social media content. The sensitivity of the curating server 108 in excluding content is selectable and/or variable to the end-user.

In one embodiment the curating server 108 can utilize originality of social media content as a criterion for inclusion or exclusion. By way of example, if numerous instances of social media content appear to be plagiarized versions of original content, these types of social media content can be excluded.

To be sure, the curating server 108 can likewise utilize natural language processing or machine learning to process the social media content as described above with respect to the news content. That is, the curating server 108 can extract textual content from the social media content and examine the extracted textual content for keywords and/or phrases. The curating server 108 can use this extracted content as a basis for comparing instances of social media content to one another. Duplicative or irrelevant social media content can be ignored by the system.

In some embodiments, the curating server 108 can rank social media content based on any of relevancy, originality, and authoritativeness. Again, relevancy relates to how the social media content corresponds to the new source. Originality relates to the uniqueness of the social media content. Content that is not original or content that is copied, borrowed, re-tweeted, or otherwise not originally created by an author may also be excluded. Authoritativeness relates to or is an aspect of the author that created the social media content. For example, an authoritative source relative to a news article relating to the release of a new iPhone could include social media content generated by a company employee of Apple, or a well-known journalist that writes about technology issues. This type of information can be deduced by examining public data sources, examining the influence of an individual or author (e.g., how many followers this individual has on various social media platforms), or other similar sources.

The curating server 108 can select highly relevant and authoritative social media content that is ranked to provide back to the processing system 102. In some embodiments, the processing system 102 provides a graphical user interface such is a webpage that includes a widget. The social media content that is curated by the curating server 108 is displayed within the widget on the webpage. In some embodiments the widget is placed proximately to a news story that was used to generate the social media content displayed within the widget.

In some embodiments, ranking of the social media content is based on the matches in the feature space. In some instances, each match results in the calculation of a relevancy score. The score depends on the number of matches and the importance of those matches by using the importance of the article feature. This score is used to filter irrelevant content and to deliver the most relevant content first. Based on the mismatches in the feature space between the article and the social media item, the originality score is calculated. This score is used to filter out items that do not have added value and to deliver the items with the most added value first. Based on the user, properties that make a social media item poster more reliable and important than other posters.

In one embodiment, for every match, the relevancy scoring properties are used to assess that the social media item is relevant enough in relation to the context. Any item that does not reach a predefined threshold is discarded. Items that have a low relevancy score are compared to other more relevant items and only the most relevant items are retained.

According to some embodiments, for every match a number of filters are used to only retain the items which have the most added value to an end user or a publisher. To this end the items are compared to the article and to each other. Any item that is too similar to the article and does not contain new information is discarded. Furthermore items should have added value with respect to each other, to achieve this functionality the items are clustered and only the best item is retained.

As another feature, the curating server 108 can select social media content based on an authoritativeness of an author. In many cultures user credibility is important (e.g., users that have a lot of followers are usually seen as more credible). A variety of user features are used to ensure that only post of credible users are retained. One feature is the connectedness in the user graph calculated by the number of in-links divided by the number of out-links. Publishers often do not want to create out-links. The curating server 108 can trace all links that are used in social media by resolving them to their canonical URL. If the final URL does not link to a resource owned by the publisher the post is discarded.

Another feature is the number of followers. Furthermore the properties of having an avatar, a proper screenname and a history of engagement are also used to filter posts based on user properties. Most social media services have a wide range of client systems that can be used to publish social media items. The client name is used as a feature to assess if a post is coming from an authoritative user.

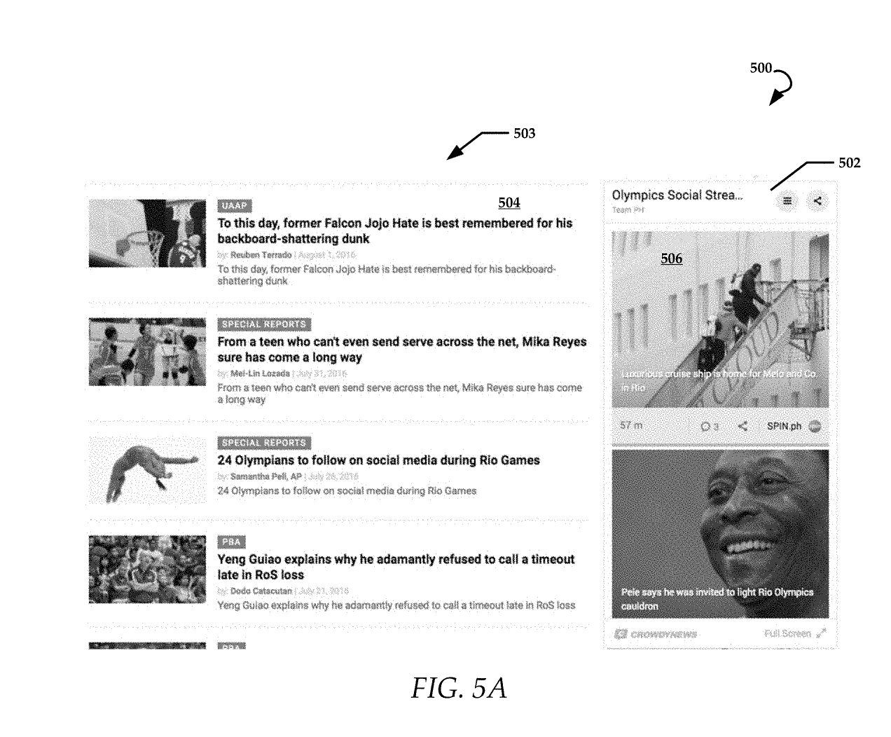

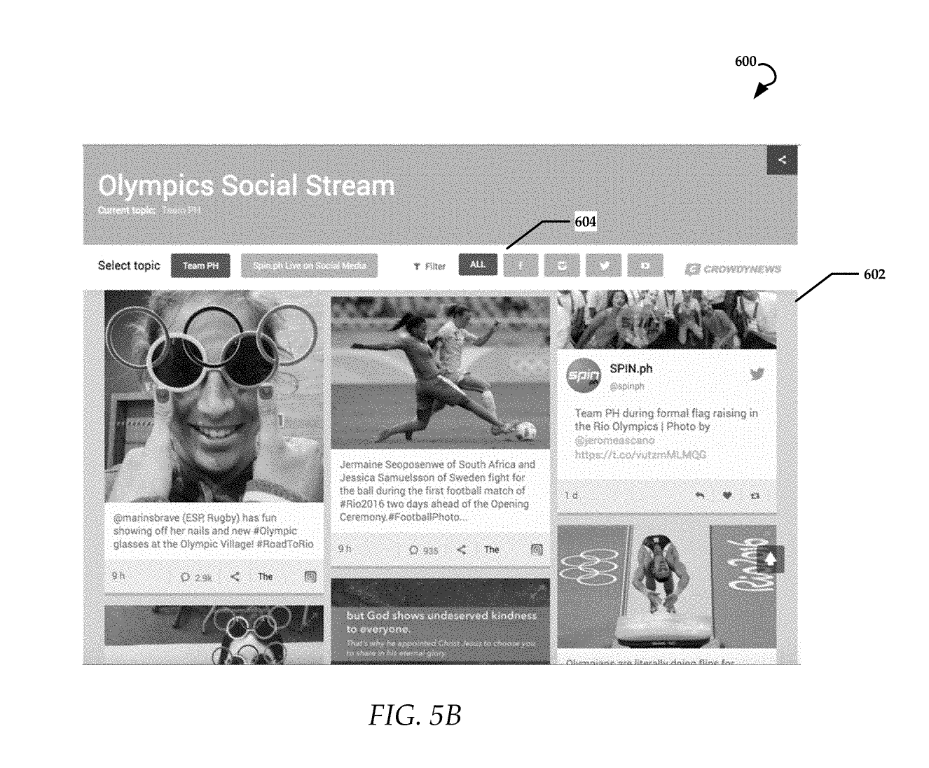

Advantageously, the social media content displayed within the widget is highly relevant to the reader of the news article. The social media content is not noisy and does not distract the reader with information that is irrelevant. FIG. 5A illustrates an example webpage comprising a widget that displays social media content in proximity to a news source.

According to some embodiments, the curating server 108 can further filter and/or rank the social media content provided within the widget by applying user preferences that are determined according to the preferences of the reader. For example, the reader may have a preference to receive social media content from authors such as celebrities and/or political figures. When the reader clicks on a news article that is relevant to the interests of the reader, the social media content search is executed and the curating server 108 can apply known user preferences included in a user profile, to filter and/or rank social media content. Thus the curated social media content is relevant, original, authoritative, and targeted to the preferences of the reader. This allows the reader to wade through a sea of social media content to find the content that is relevant to the information they are interested in consuming.

In some embodiments, widgets are able to display the content retrieved from the API's mentioned above. These widgets are able to retrieve the desired content collection by using a predefined configuration script or by using the context in which the widget is displayed.

The curating server 108 can deliver the most relevant content that is safe and of added value, and depending on the cultural bias of the customer a highly configurable filtering system is used.

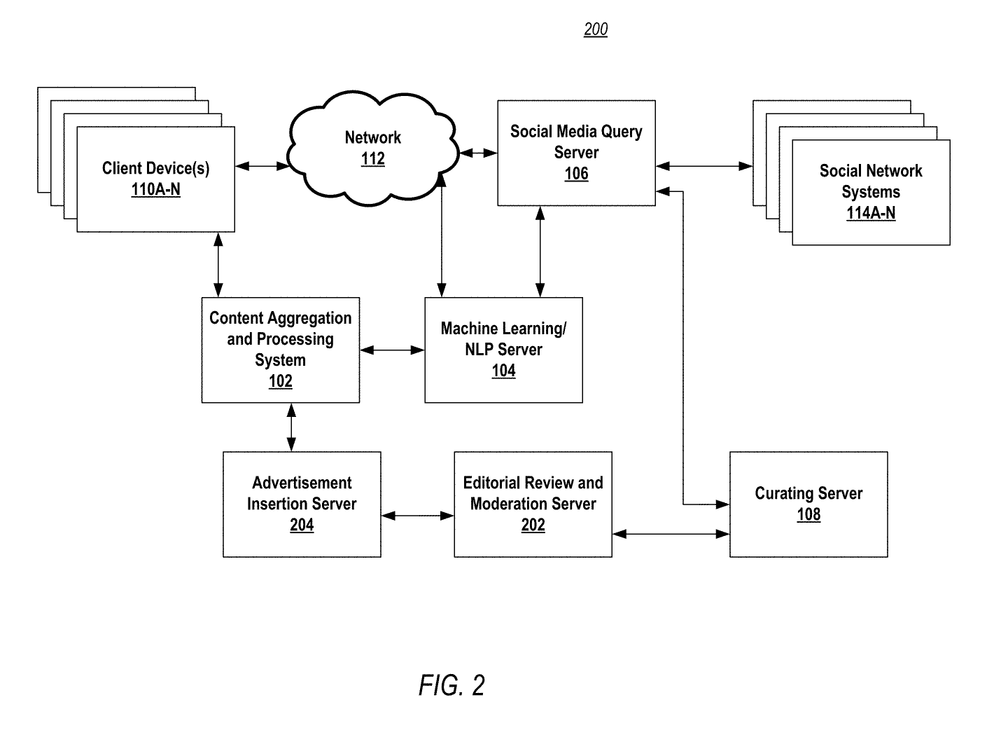

FIG. 2 illustrates another example embodiment of a system 200 of the present disclosure. The system 200 is constructed in a manner that is identical to the system 100 of FIG. 1, with the exception that the system 200 additionally comprises an editorial and moderation server 202 and an advertisement insertion server 204.

In one embodiment, the curating server 108 transmits curated social media content to the editorial and moderation server 202. The editorial and moderation server 202 allows editors and/or moderators to further curate the social media content. In one embodiment, the editorial and moderation server 202 can remove social media content that includes racist, inflammatory, and or profane content. Again, this functionality can be provided in accordance with user preferences. In some embodiments, the editorial and moderation server 202 can implement a moderation rule (e.g., content guidelines) set to automatically filter out any unwanted social media content regardless of its relevancy, originality, and authority. For example, the content guidelines can specify a list of words or phrases that are deemed unacceptable.

In some embodiments, the advertisement insertion server 204 can be utilized to insert advertisements into the widget provided on the webpage. The advertisements can be targeted to the relevant topics at hand and or the preferences of the reader/end-user. By way of example, a banner advertisement for iPhone accessories can be included in the widget when displaying social media content that is relevant to the launch of the new iPhone.

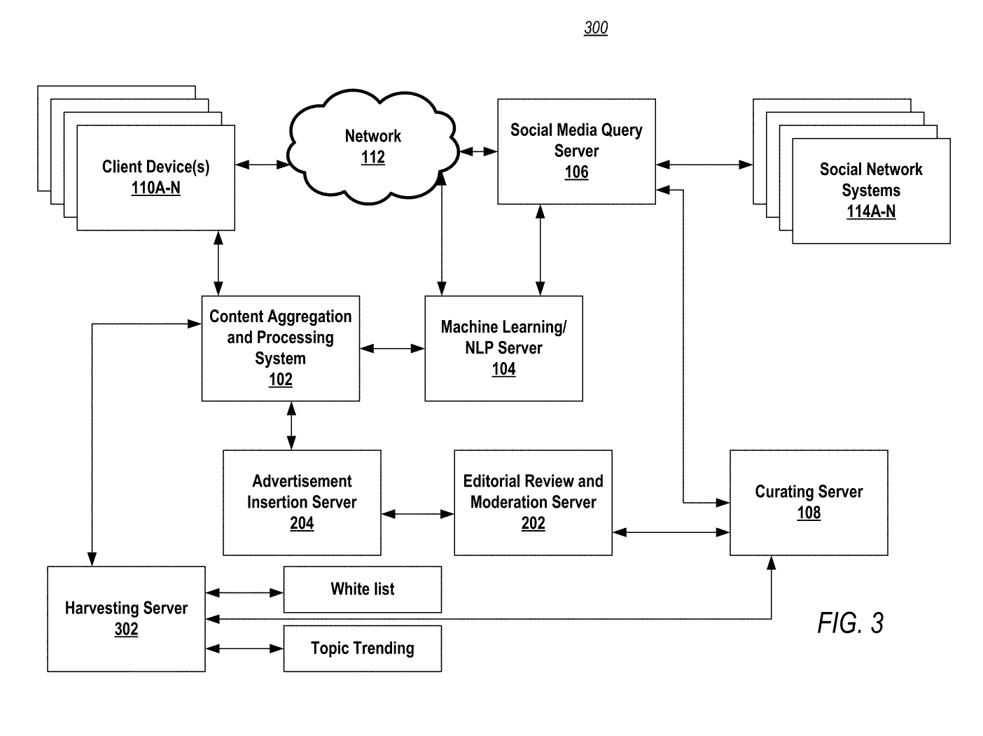

FIG. 3 illustrates another example system 300 constructed in accordance with the present disclosure. The system 300 is identical to the systems 100 and 200 described above, with the exception that the system 300 comprises a harvesting server 302. In some embodiments, the harvesting server 302 can also utilize white listing, trending, and other similar functionalities.

In general, the harvesting server 302 can utilize the curated social media content to generate what is effectively crowdsourced news articles that can be published to the public. As mentioned above, the systems of the present disclosure can obtain new sources from a wide variety of diverse sources. Additionally, social media content provides further diversity and depth to locate information that is highly relevant to a topic. A harvested or crowdsourced type of content generated by the harvesting server 302 provides news content that is a cross-section of journalism and social media commentary.

In one embodiment, the harvesting server 302 can utilize white lists of sources and or topics, excluding other types of information sources. This is effective in reducing the amount of editorial review and moderation used prior to providing the social media content in the widget. In some embodiments, the harvesting server 302 can utilize trending news topics as the basis for determining which news articles and corresponding social media content are worthy of being crowdsourced and provided to the public. Trending news topics can be determined by examining content training on social media platforms such as frequently used hashtags in trending lists utilized by other social media platforms. Trending news topics can also be determined by tracking the news articles selected for viewing by readers within the processing system that provides the news articles as described herein, such as processing system 102 of FIG. 1.

As is illustrated in FIG. 3, the harvesting server 302 receives curated social media from the processing system 102. The harvesting server 302 can then generate crowdsourced news articles from the curated social media content, and deliver the crowdsourced news articles back to the processing system 102 for publishing. The term “crowdsourcing” as used herein, involves the amalgamation or aggregation of news article content, social media content, and specifically curated social media content, into a feed and/or document that is published to the public. For example an HTML webpage can be generated and published that includes the crowdsourced news.

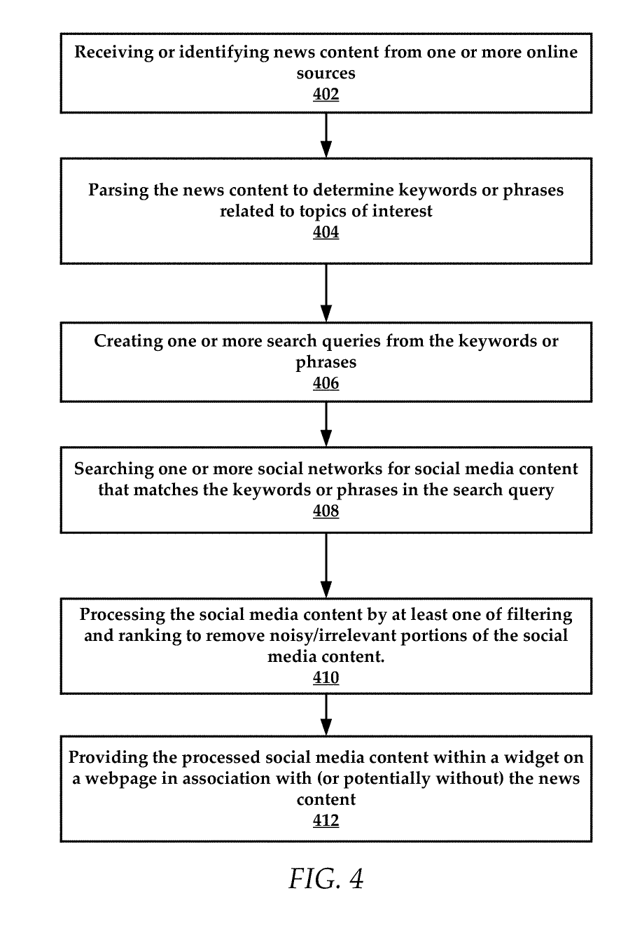

FIG. 4 is a flow chart of an example method that can be executed using one or more of the systems described above. In one embodiment, the method includes a step 402 of receiving news content from one or more online sources. Again, this can include a reader selecting a news article or topic on a website, or an article feed from an RSS stream. The method then includes a step 404 of parsing the news content to determine keywords or phrases related to topics of interest. In one embodiment, the parsing includes using natural language processing and machine learning to extract relevant words related to topics of interest.

Once the keywords or phrase are determined the method includes a step 406 of creating one or more search queries from the keywords or phrases. The one or more search queries are tailored to the requirements of specific social networks, for example, tailored to a public API of the social network. Thus, the systems maintain and implement logic that allows search queries to be executed across many social networks. In some embodiments, the social networks that are searched are selected by the reader.

In one embodiment, the method comprises a step 408 of searching one or more social networks for social media content that matches the keywords or phrases in the search query. The social media content is returned in a raw or unfiltered format. In accordance with the present disclosure, this raw or unfiltered social media content is processed. The method includes a step 410 of processing the social media content by at least one of filtering and ranking, as well as a step 412 of providing the processed social media content within a widget on a webpage in association with the news content. Again, the processing of the social media content is executed to reduce the noise and/or amount of social media content that is irrelevant to the reader and/or the topic of the news content.

FIG. 5A is a screenshot of a web page 500 that comprises a widget 502 of the present disclosure. The web page 500 comprises an RSS feed 503 or other input of news sources such as online articles 504. The systems and methods of the present disclosure are used to extract features from the news articles in the RSS feed 502, create social media search queries, process the query responses (using ranking, filtering, editing, and combinations thereof), and create curated social media content, such as social media content 506, that is presented within the widget 502. Each instance of processed social media content can be represented within the widget 502 by an image and short textual synopsis in some embodiments.

In some embodiments, rather than utilizing a widget, the systems of the present disclosure provide an API that allows the curated content to be published to a customer resource management (CRM) platform, a content management system (CMS), an analytics suite (for creation and tracking of various metrics of news sources, social media content, and curated content by the system)—just to name a few.

FIG. 5B illustrates an example web page 600 that comprises a social media stream 602 created from curated social media content. In this embodiment the user can select which social media platforms are included in the stream using menu 604. In one embodiment, instances of curated social media content are arranged in a tiled configuration on the web page.

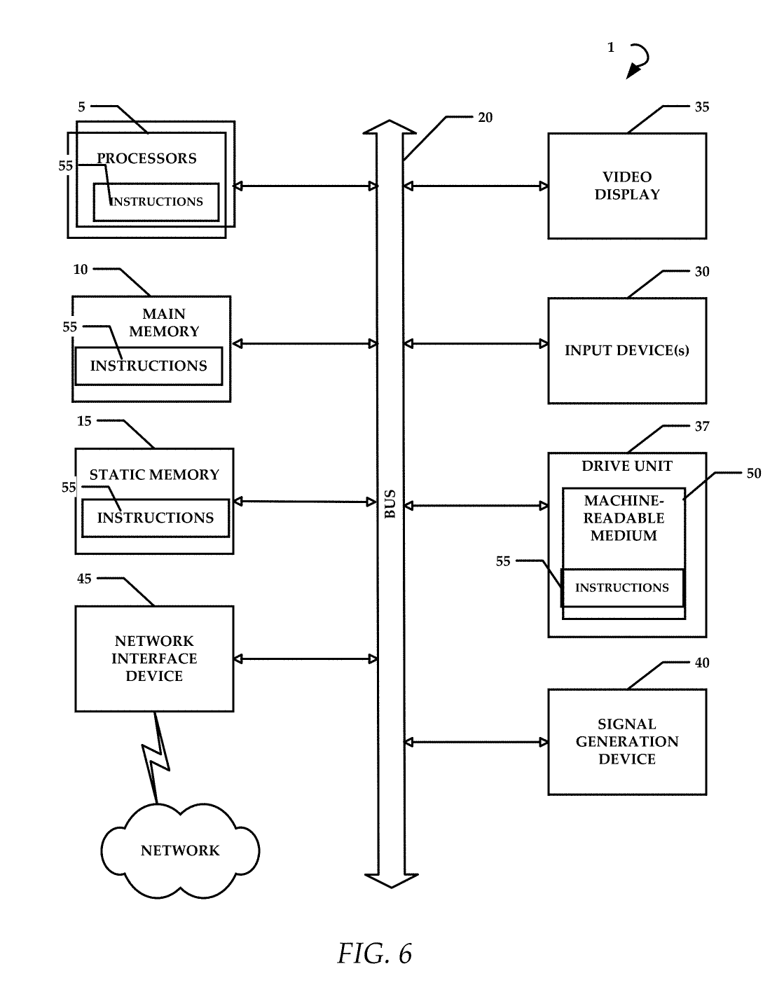

FIG. 6 is a diagrammatic representation of an embodiment of a machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a robotic construction marking device, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The embodiment of the computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. The description herein is illustrative and not restrictive. Many variations of the technology will become apparent to those of skill in the art upon review of this disclosure. For example, the technology is not limited to use for stopping email threats, but applies to any messaging threats including email, social media, instant messaging, and chat.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

1. A method, comprising:
receiving, by an aggregation server, news content from a plurality of online sources;
parsing, by a parsing server, the news content to determine keywords or phrases related to topics of interest of an individual, the topics of interest being determined based on at least one new content selected by the individual in one of the plurality of online sources;
creating, by a social network server, a search query from the keywords or phrases;
searching, by the social network server, one or more social networks for social media content that matches the keywords or phrases in the search query;
processing, by a filtering server, the social media content by at least one of filtering and ranking; and
providing, by the aggregation server, the processed social media content to the individual.

2. The method according to claim 1, wherein the social media content comprises user-generated content by participants in the one or more social networks.

3. The method according to claim 1, wherein the processed social media content is provided as an aggregated news feed.

4. The method according to claim 1, further comprising providing a targeted advertisement along with the processed social media content.

5. The method according to claim 1, further comprising:
harvesting content from the processed social media content;
creating crowdsourced news content from the harvested content; and
publishing the crowdsourced news content.

6. The method according to claim 5, further comprising applying a whitelist to the harvested content to restrict topics or information included in the crowdsourced news content.

7. The method according to claim 5, further comprising identifying trending topics that are used as the basis for obtaining the social media content.

8. The method according to claim 1, further comprising inserting editorialized content into the processed social media content.

9. The method according to claim 1, further comprising moderating the processed social media content to remove the social media content that does not correspond to content guidelines.

10. A system, comprising:
an aggregation server that receives news content from a plurality of online sources;
a parsing server that parses the news content to determine keywords or phrases related to topics of interest of an individual, the topics of interest being determined based on at least one new content selected by the individual in one of the plurality of online sources;
a social network server that:
creates a search query from the keywords or phrases; and
searches one or more social networks for social media content that matches the keywords or phrases in the search query;
a filtering server that processes the social media content by at least one of filtering and ranking; and
wherein the aggregation server is further configured to provide the processed social media content to the individual.

11. The system according to claim 10, further comprising a harvesting server that:
harvests content from the processed social media content;
creates crowdsourced news content from the harvested content; and
provides the crowdsourced news content in combination with the news content.

12. A method comprising:
receiving, by an aggregation server, news content from one or more online sources;
parsing, by a parsing server, the news content to determine keywords or phrases related to topics of interest of an individual, the topics of interest being determined based on at least one new content selected by the individual in one of the plurality of online sources;
creating, by a social network server, one or more search queries from the keywords or phrases, where the one or more search queries is tailored to the requirements of specific social networks;
searching, by the social network server, one or more social networks for social media content that matches the keywords or phrases in the search query;
processing, by the aggregation server, the social media content by at least one of filtering and ranking; and
providing the processed social media content within a widget on a webpage in association with the news content.

13. The method according to claim 12, wherein filtering comprises selecting a portion of the social media content that is relevant to the keywords or phrases, is original content generated by an author, and the author is authoritative.

14. The method according to claim 12, wherein filtering further comprises utilizing a user profile of an end user to select the social media content that is relevant to the end user, wherein the user profile comprises preferences of the end user.

15. The method according to claim 12, wherein the social media content selected is selected from social media content that is relevant to the keywords or phrases, original, and generated from an authoritative source.

16. The method according to claim 12, further comprising:
harvesting content from the processed social media content;
creating crowdsourced news content from the harvested content; and
providing the crowdsourced news content to at least a portion of the plurality of online sources.

17. The method according to claim 16, further comprising applying a whitelist to the harvested content to restrict topics or information included in the crowdsourced news content.

18. The method according to claim 12, wherein providing the processed social media content within a widget on a webpage further comprises placing the widget in proximity to the news content.
